(19) United States
(12) Patent Application Publication
(10) Pub. No.: US 2011/0175013 A1
(43) Pub. Date: Jul. 21, 2011

(54) COMPOSITE MAGNETIC MATERIAL AND PROCESS FOR PRODUCING THE COMPOSITE MAGNETIC MATERIAL

(76) Inventors: Takeshi Takahashi, Kyoto (JP); Yuya Wakabayashi, Hyogo (JP)

(21) Appl. No.: 13/121,629

(22) PCT Filed: Sep. 30, 2009
(86) PCT No.: PCT/JP2009/005015

§ 371 Date: Mar. 29, 2011

(30) Foreign Application Priority Data
Oct. 1, 2008 (JP) 2008-256032

(51) Int. Cl. H01F 1/04; H01F 41/00

(52) U.S. Cl. 252/62.55; 264/109

(57) ABSTRACT

The present invention is intended to provide composite magnetic material having excellent soft magnetic characteristics that can reduce the size of electromagnetic components such as inductors, choke coils, and transformers and is usable in a high frequency range. The composite magnetic material of the present invention includes substantially spherical magnetic metal powder, flat inorganic insulating material interposed between the magnetic metal powder, and a binder, in which the magnetic metal powder has an aspect ratio of not more than 3, and the inorganic insulating material has an aspect ratio of not less than 2 and is cleavable. The present invention also provides a process for producing the composite magnetic material, which includes carrying out pressure-forming while crushing the inorganic insulating material.

### TECHNICAL FIELD

The present invention relates to a composite magnetic body used in an inductor, a choke coil, a transformer, or the like, of electronic equipment.

### BACKGROUND ART

Recently, with the trend toward downsizing in electric and electronic equipment, a magnetic body also has been demanded to have a small size and high efficiency. A conventional magnetic body, for example, includes a ferrite magnetic core using ferrite powder or a powder magnetic core as a formed product of magnetic metal powder in a choke coil used in a high frequency circuit.

Among them, the ferrite magnetic core has defects that a saturation magnetic flux density is small and the DC bias characteristic is poor. Therefore, in a conventional ferrite magnetic core, in order to secure the DC bias characteristic, a gap of several hundred microns is provided in a direction vertical to the magnetic path to prevent the reduction of an inductance L value at the time of DC bias. Such a wide gap, however, may be a source of beat sound. Furthermore, a leakage magnetic flux generated from a gap may increase a copper loss in winding particularly in a high-frequency band.

On the contrary, the powder magnetic core produced by forming magnetic metal powder has an extremely large saturation magnetic flux density as compared with the ferrite magnetic core, so that it is advantageous in reducing size. Furthermore, unlike the ferrite magnetic core, the powder magnetic core can be used without using a gap, so that beat sound and a copper loss due to a leakage magnetic flux are small.

However, in terms of the magnetic permeability and the core loss, the powder magnetic core is not superior to the ferrite core. In particular, a powder magnetic core used in a choke coil or an inductor results in a greater temperature rise corresponding to the greater core loss, thus making it difficult to reduce the size. Furthermore, in the powder magnetic core, in order to improve the magnetic characteristics, a forming density is required to be increased. In manufacture, not less than 5 ton/cm² of forming pressure is generally required. For some products, not less than 10 ton/cm² of forming pressure is required.

The core loss of the powder magnetic core generally consists of a hysteresis loss and an eddy current loss. Since metal material has a low intrinsic resistance value, with respect to the change of the magnetic field, an eddy current flows so as to suppress the change, thus posing a problem of the eddy current loss. The eddy current loss increases in proportion to the square of frequency and the square of a flowing size of the eddy current. Therefore, by covering the surface of the magnetic metal powder with insulating material, the flowing size of the eddy current can be suppressed to only a portion in magnetic metal powder particles from the entire core between the magnetic metal powder particles. This makes it possible to reduce the eddy current loss.

On the other hand, as to the hysteresis loss, since the powder magnetic core is formed at a high pressure, much process strain is introduced in the magnetic body, and the magnetic permeability is reduced, which increases the hysteresis loss. In order to avoid this, after the powder magnetic core is formed, heat treatment for relieving strain is carried out if necessary. In general, in metal material, strain is relieved at a temperature that is not less than ½ of the melting point. Therefore, in order to sufficiently relieve strain in an Fe-rich alloy, it is necessary to carry out heat treatment at a temperature of at least not less than 600° C. and preferably not less than 700° C.

That is to say, in the powder magnetic core, it is important to achieve high-temperature heat treatment in a state in which the insulation between magnetic metal powders is secured.

However, most organic resins such as an epoxy resin, a phenol resin, and a vinyl chloride resin, used as an insulating binding agent of a conventional powder magnetic core has a low heat resistance. Therefore, when high-temperature heat treatment is carried out in order to relieve strain of the powder magnetic core, conventional insulating binding agents are thermally decomposed, so that such insulating binding agents cannot be used.

On the contrary, a method using, for example, a polysiloxane resin as an insulating binding agent is proposed (see, for example, Patent Literature 1).

However, for example, in technology proposed in Patent Literature 1, a heat-resistant temperature is about 500° C. to 600° C., and it is difficult to carry out heat treatment at temperatures of not less than this temperature range.

### CITATION LIST

### Patent Literature

[Patent Literature 1] Japanese Patent Application Unexamined Publication No. H6-29114

### SUMMARY OF THE INVENTION

The present invention provides composite magnetic material that can be subjected to high-temperature heat treatment and that achieves an excellent soft magnetic property.

The present invention provides composite magnetic material including substantially spherical magnetic metal powder, flat inorganic insulating material interposed among the magnetic metal powder, and a binder, in which the magnetic metal powder has an aspect ratio of not more than 3, and the inorganic insulating material has an aspect ratio of not less than 2 and is cleavable.

Furthermore, a process for producing composite magnetic material includes: adding, mixing and dispersing flat inorganic insulating material to substantially spherical magnetic metal powder; adding a binder thereto, and kneading and dispersing them; pressure-forming the inorganic insulating material while crushing so as to form a formed product; and heat-treating the formed product. The magnetic metal powder has an aspect ratio of not more than 3, and the inorganic insulating material has an aspect ratio of not less than 4 and is cleavable.

In the composite magnetic material of the present invention, inorganic insulating material having excellent heat resistance is interposed between magnetic metal powders. This makes it possible to sufficiently secure an insulating property between the magnetic metal powder at the time of high-temperature heat treatment and to achieve composite magnetic material having an excellent magnetic property. Furthermore, inorganic insulating material is flat and cleavable and has an excellent lubricating ability and low fracture strength, so that it can be easily crushed during pressure-forming. Therefore, the magnetic metal powder can be highly filled and the inorganic insulating material can be interposed among the above-mentioned magnetic metal powder reliably. Thus, it is possible to achieve excellent composite magnetic material that can be subjected to high-temperature heat treatment.

### DETAILED DESCRIPTION OF THE PREFERRED EMBODIMENTS

The following are descriptions of composite magnetic material and its production process in accordance with an exemplary embodiment of the present invention.

Firstly, inorganic insulating material used in composite magnetic material in accordance with this exemplary embodiment is described.

The inorganic insulating material used in the composite magnetic material in accordance with this exemplary embodiment is cleavable, and preferably is at least one selected from boron nitride, talc, and mica. Since these inorganic insulating materials have excellent heat resistance, they can be subjected to high-temperature heat treatment. Furthermore, since they are cleavable, they show an excellent lubricating ability and have low fracture strength. Therefore, magnetic metal powder can be highly filled at the time of pressure-forming.

In a compaction process in the pressure-forming, at the initial stage, it is preferable that the closest packing occurs by rearrangement of magnetic metal powder by the movement of magnetic metal powder and then high filling occurs due to plastic deformation. When the frictional resistance between magnetic metal powder is large, magnetic metal powder cannot move easily, and plastic deformation occurs before the magnetic metal powder take the closest-packed structure, thus making it difficult to be highly filled.

However, the above-mentioned cleavable inorganic insulating material exhibits an excellent lubricating ability. Therefore, when the inorganic insulating material is interposed between the magnetic metal powder, the magnetic metal powder can be easily rearranged and closest packed. Furthermore, since the inorganic insulating material has low fracture strength, and can be easily crushed at the time of plastic deformation, so that the plastic deformation of the magnetic metal powder is not easily prevented, thus enabling high filling to be carried out.

Furthermore, it is preferable that the inorganic insulating material used in this exemplary embodiment is flat. When the inorganic insulating material is flat, a crushing property can be improved as compared with a spherical shape. Thus, the inorganic insulating material can be easily crushed at the time of plastic deformation. Therefore, the plastic deformation of the magnetic metal powder is not prevented easily, thus enabling high filling to be carried out. It is more preferable that the aspect ratio of this flat shape is not less than 4. Note here that the aspect ratio is a ratio of the length of the major axis to the length of the minor axis (length of the major axis/length of the minor axis) when a particle shape is observed two-dimensionally. The upper limit of the aspect ratio is not particularly limited from the viewpoint of the above-mentioned effect, but it is preferably not more than 100 from the viewpoint of the cost.

Furthermore, another reason why the aspect ratio is made to be not less than 4 follows.

In a powder magnetic core as the composite magnetic material in this exemplary embodiment, inorganic insulating material interposed between magnetic metal powder in the powder magnetic core has preferably a flat shape and more preferably has an aspect ratio of not less than 2. When flat powder is used, as compared with spherical powder, the insulating property between magnetic metal powder can be easily secured and the addition amount can be reduced. Furthermore, the filling rate of the magnetic metal powder in the powder magnetic core can be increased, and high magnetic characteristics can be achieved. When the aspect ratio is less than 2, such an effect cannot be obtained. As a result of considering the control of the aspect ratio of the inorganic insulating material in the powder magnetic core, it is preferable that the aspect ratio of the inorganic insulating material to be used as raw material is not less than 4. When the aspect ratio is less than 4, it is difficult that the aspect ratio of the inorganic insulating material in the powder magnetic core is made to be not less than 2. Since the upper limit of the aspect ratio of the raw material is preferably not more than 100 as mentioned above, the upper limit of the aspect ratio of the inorganic insulating material in the core duct results in not more than 100, and preferably about not more than 90 because it is crushed during pressure-forming.

Note here that when the average length of the major axis of the inorganic insulating material in the powder magnetic core is sufficiently less than the average particle diameter of the magnetic metal powder, only an insulating property—that is the same level as the case using a spherical powder can be obtained. Therefore, in order to secure the sufficient insulating property, it is necessary to increase the addition amount of inorganic insulating material. As a result, the filling rate of the magnetic metal powder in the powder magnetic core is reduced, so that the soft magnetic property is reduced. On the other hand, the average length of the major axis of the inorganic insulating material in the powder magnetic core is too much larger than the average particle diameter of the magnetic metal powder, the magnetic metal powders are partially brought into contact with each other, thus making it difficult to sufficiently secure the insulating property between the magnetic metal powders. Consequently, an eddy current loss is increased. The preferable average length of the major axis of the inorganic insulating material in the powder magnetic core is in the range from 0.02 to 1 time with respect to the average particle diameter of the magnetic metal powder.

Furthermore, it is preferable that the addition amount of the inorganic insulating material is made to be within the range of 0.1 to 5 parts by weight with respect to 100 parts by weight of the magnetic metal powder. When the addition amount is less than 0.1 parts by achieved sufficiently, and it is difficult to secure the insulating property between magnetic metal powder. When it is more than 5 parts by weight, the filling rate of the magnetic metal powder in the powder magnetic core is reduced, thus deteriorating the soft magnetic property.

Next, the magnetic metal powder used in this exemplary embodiment is described. The magnetic metal powder used in this exemplary embodiment includes at least Fe, and is preferably at least one selected from Fe, Fe—Si, Fe—Ni, Fe—Ni—Mo, and Fe—Si—Al based powder.

The Fe—Si based powder used in this exemplary embodiment includes not less than 1 wt % and not more than 8 wt % of Si and the remainder including Fe and inevitable impurities. Si plays a role in improving the soft magnetic property, and has the effect of reducing the magnetic anisotropy and the magnetostriction constant, enhancing the electric resistance, and reducing the eddy current loss. It is preferable that the addition amount of Si is not less than 1 wt % and not more than 8 wt %. When the addition amount is less than 1 wt %, the effect of improving the soft magnetic property is poor. When the addition amount is more than 8 wt %, the reduction of the saturation magnetization becomes large, thus deteriorating the DC bias characteristic.

The Fe—Ni based powder used in this exemplary embodiment includes not less than 40 wt % and not more than 90 wt % of Ni and the remainder including Fe and inevitable impurities. Ni plays a role in improving the soft magnetic property. The addition amount of Ni is preferably not less than 40 wt % and not more than 90 wt %. When the addition amount is less than 40 wt %, the effect of improving the soft magnetic property is poor. When the addition amount is more than 90 wt %, the reduction of the saturation magnetization becomes large, thus deteriorating the DC bias characteristic. Furthermore, 1 to 6 wt % of Mo may be added in order to improve the magnetic permeability.

The Fe—Si—Al based powder used in this exemplary embodiment includes not less than 8 wt % and not more than 12 wt % of Si, not less than 4 wt % and not more than 6 wt % of Al, and the remainder including Fe and inevitable impurities. Si and Al play a role in improving the soft magnetic property, and they are preferably added in the above-mentioned composition ranges. When the addition amounts of Si and Al are smaller than the above-mentioned composition ranges, the effect of improving the soft magnetic property is poor. When the addition amounts are more than the above-mentioned composition ranges, the reduction of the saturation magnetization becomes large, thus deteriorating the DC bias characteristic.

It is preferable that the average particle diameter of the magnetic metal powder used in this exemplary embodiment is not less than 1 μm and not more than 100 μM. It is not preferable that the average particle diameter is less than 1 μm because the forming density is reduced and the magnetic permeability is reduced. It is not preferable that the average particle diameter is more than 100 μm because an eddy current loss in the high frequency becomes large. It is more preferable that the average particle diameter is not more than 50 μm. Note here that the average particle diameter of the magnetic metal powder is calculated by a laser diffraction particle size distribution measuring method. For example, a particle diameter of measured particle showing the same pattern of diffracted/scattered light as that of a 10 μm-diameter sphere is defined to be 10 μm regardless of their shapes.

It is preferable that the shape of the magnetic metal powder used in this exemplary embodiment has a substantially spherical shape. It is not preferable that flat magnetic metal powder is used because the powder magnetic core is provided with a magnetic anisotropy and a magnetic circuit configuration is limited. The aspect ratio is preferably not more than 3 and more preferably not more than 1.5.

A method for producing magnetic metal powder used in this exemplary embodiment is not particularly limited and various atomization methods can be used and various crushed powder can be used.

A method for mixing and dispersing the magnetic metal powder and the inorganic insulating material in this exemplary embodiment is not particularly limited, and various ball mills such as a rotary ball mill and a planetary ball mill, a V blender, and a planetary mixer, and the like, can be used.

The binder used in this exemplary embodiment is preferably a binder that remains as an oxide after high-temperature heat treatment, and examples of the binder include a silane coupling agent, a titanium coupling agent, a chromium coupling agent, an aluminum coupling agent, a silicone resin, and the like. The remaining oxides are capable of binding a magnetic metal powder to inorganic insulating the high-temperature heat treatment.

Note here that an epoxy resin, an acrylic resin, a butyral resin, a phenol resin, and the like, can be partially added as auxiliary agents. Furthermore, the method for mixing and dispersing the binder is not particularly limited, and, for example, a method used for mixing and dispersing the magnetic metal powder and oxide powder can be used.

The pressure-forming method in this exemplary embodiment is not particularly limited, and usual pressure-forming methods may be used. It is preferable that the forming pressure is not less than 5 ton/cm² and not more than 20 ton/cm². When the forming pressure is less than 5 ton/cm², the filling rate of the magnetic metal powder is low, so that high magnetic characteristics cannot be obtained. When the forming pressure is more than 20 ton/cm², the size of a form is increased to secure the strength of the form during pressure-forming becomes large, thus increasing the size of a press machine. Furthermore, due to the increase in the size of the form and the press machine, the productivity is reduced, thus increasing the cost.

The purpose of the heat treatment after pressure-forming in this exemplary embodiment is to prevent the reduction of magnetic characteristics due to the process strain introduced into the magnetic metal powder during pressure-forming and to relieve the process strain. The heat treatment temperature is preferably high, but it is not preferable that the temperature is increased too high because insulation between powder particles becomes insufficient, thus increasing an eddy current loss. The heat treatment temperature is preferably in the range from 600° C. to 1000° C. When the heat treatment temperature is lower than 600° C., relieving of the process strain is not sufficient and the magnetic characteristics are deteriorated. It is not preferable that the heat treatment temperature is higher than 1000° C. because insulation between powder particles becomes insufficient, and an eddy current loss is increased.

The heat treatment atmosphere is preferably a non-oxidative atmosphere because the deterioration of the soft magnetic property due to the oxidation of the magnetic metal powder is suppressed. Examples of the preferable atmospheres include an inert atmosphere such as argon gas, nitrogen gas, helium gas, and the like, a reducing atmosphere such as a hydrogen gas and the like, and a vacuum atmosphere.

Hereinafter, Examples of the composite magnetic material of the present invention are described.

### Example 1

Fe—Si—Al based magnetic metal powder having an average particle diameter of 24 μM and including 8.9 wt. % of Si and 5.9 wt. % of Al is prepared. To 100 parts by weight of the prepared magnetic metal powder, 0.8 parts by weight of various inorganic insulating material described in Table 1 and having an average length of the major axis of 4 μm and various aspect ratios are added and mixed so as to form mixed powder. To 100 parts by weight of the obtained mixed powder, 1.0 part by weight of silicone resin is added and then a small amount of toluene is added, followed by kneading and dispersing to form a compound. The obtained compound is pressure-formed at 10 ton/cm² and heat-treated in an argon gas atmosphere at 850° C. for 1.0 h. Note here that the shape of the formed sample is a toroidal core having an outer diameter of 14 mm, an inner diameter of 10 mm, and a height of about 2 mm.

The obtained samples are evaluated for the DC bias characteristic, core loss, and aspect ratio of inorganic insulating material in each sample. The DC bias characteristic is evaluated by measuring the magnetic permeability at the applied magnetic field of 55 Oe and at the frequency of 120 kHz by using an LCR meter. The core loss is measured at the measurement frequency of 120 kHz and measurement magnetic flux density of 0.1 T by using an alternating B-H curve measurement device. Furthermore, the aspect ratio is measured by observing the fracture surface of the sample. The obtained results are shown in Table 1.

TABLE 1

| | Inorganic | Aspect ratio | Magnetic | | |
|---|---|---|---|---|---|
| Sample | insulating | of inorganic | perme- | Core loss | |
| No. | material | insulating | ability | (kW/m3) | |
| 1 | boron | 10 | 58 | 300 | Example |
| | nitride | | | | |
| 2 | talc | 2 | 45 | 420 | Example |
| 3 | talc | 30 | 61 | 290 | Example |
| 4 | mica | 2 | 48 | 405 | Example |
| 5 | mica | 5 | 49 | 380 | Example |
| 6 | boron | 2 | 47 | 420 | Example |
| | nitride | | | | |
| 7 | mica | 80 | 52 | 310 | Example |
| 8 | talc | 1.5 | 41 | 460 | Comparative |
| | | | | | Example |
| 9 | alumina | 15 | 40 | 505 | Comparative |
| | | | | | Example |
| 10 | silica | 1 | 35 | 650 | Comparative |
| | | | | | Example |

Table 1 shows that composite magnetic material of this exemplary embodiment in which the inorganic insulating material in the powder magnetic core is cleavable and the aspect ratio is not less than 2 have an excellent DC bias characteristic and a low core loss. Sample No. 9 uses alumina as the inorganic insulating material, and has an aspect ratio of not less than 2, but it is not cleavable. Sample No. 8 uses talc as the inorganic insulating material and is cleavable, but has an aspect ratio of less than 2. Sample No. 10 uses silica as inorganic insulating material, is not cleavable and has an aspect ratio of less than 2.

### Example 2

Fe—Ni based magnetic metal powder having an average particle diameter of 15 μm, and including 49.5 wt. % of Ni is prepared. To 100 parts by weight of the prepared magnetic metal powder, 1.0 part by weight of various inorganic insulating material described in Table 2 having an average length of the major axis of 3 μm and having various aspect ratios are added and mixed so as to form mixed powder. To 100 parts by weight of the obtained mixed powder, 0.7 parts by weight of aluminum coupling material and 0.6 parts by weight of butyral resin are added, and then a small amount of ethanol is added, followed by kneading and dispersing to form a compound. The obtained compound is pressure-formed at 9 ton/cm², and heat-treated in a nitrogen gas atmosphere at 790° C. for 0.5 h. Note here that the shape of the formed sample is a toroidal core having an outer diameter of 14 mm, an inner diameter of 10 mm, and a height of about 2 mm.

The obtained samples are evaluated for the DC bias characteristic, core loss, and aspect ratio of inorganic insulating material in each sample. The DC bias characteristic is evaluated by measuring the magnetic permeability at the applied magnetic field of 50 Oe and at the frequency of 120 kHz by using an LCR meter. The core loss is measured at a measurement frequency of 110 kHz and a measurement magnetic flux density of 0.1 T by using an alternating B-H curve measurement device. Furthermore, the aspect ratio is measured by observing the fracture surface of the sample. The obtained results are shown in Table 2.

TABLE 2

| | | Aspect | | | | |
|---|---|---|---|---|---|---|
| | Inorganic | ratio | | | | |
| | insulating | Raw | | Magnetic | Core loss | |
| Sample No. | material | material | In core | permeability | (kW/m3) | |
| 11 | boron nitride | 40 | 32 | 72 | 590 | Example |
| 12 | boron nitride | 20 | 14 | 66 | 610 | Example |
| 13 | boron nitride | 4 | 2.4 | 59 | 660 | Example |
| 14 | boron nitride | 100 | 79 | 67 | 605 | Example |
| 15 | boron nitride | 3 | 1.4 | 49 | 700 | Comparative |
| | | | | | | Example |
| 16 | boron nitride | 2 | 1.2 | 47 | 740 | Comparative |
| | | | | | | Example |
| 17 | talc | 50 | 36 | 75 | 580 | Example |
| 18 | talc | 15 | 6 | 62 | 630 | Example |
| 19 | talc | 4 | 2.1 | 57 | 670 | Example |
| 20 | talc | 100 | 71 | 69 | 600 | Example |
| 21 | talc | 3 | 1.2 | 46 | 760 | Comparative |
| | | | | | | Example |
| 22 | talc | 2 | 1.1 | 44 | 800 | Comparative |
| | | | | | | Example |
| 23 | mica | 60 | 48 | 71 | 600 | Example |
| 24 | mica | 30 | 18 | 68 | 605 | Example |
| 25 | mica | 4 | 2.7 | 59 | 670 | Example |
| 26 | mica | 100 | 89 | 65 | 610 | Example |
| 27 | mica | 3 | 1.7 | 48 | 710 | Comparative |
| | | | | | | Example |
| 28 | mica | 2 | 1.4 | 46 | 760 | Comparative |
| | | | | | | Example |

Table 2 shows that when the aspect ratio of the inorganic insulating material as raw material is set to not less than 4, an excellent DC bias characteristic and a low core loss are exhibited. Furthermore, it is shown that when the aspect ratio is not less than 4, the aspect ratio of the inorganic insulating material in the toroidal core as the powder magnetic core can be set to not less than 2.

### Example 3

Fe—Si based magnetic metal powder having an average particle diameter of 20 μm and including 4.9 wt. % of Si is prepared. To 100 parts by weight of the prepared magnetic metal powder, 2 parts by weight of various kinds of mica described in Table 3 and having an aspect ratio of 5 and having various average lengths of the major axis, as inorganic insulating material, are added and mixed so as to form mixed powder. To 100 parts by weight of the obtained mixed powder, 1.0 part by weight of silicone resin is added and then a small amount of toluene is added, followed by kneading and dispersing to form a compound. The obtained compound is pressure-formed at 15 ton/cm², and heat-treated in an argon gas atmosphere at 900° C. for 1.0 h. Note here that the shape of the formed sample is a toroidal core having an outer diameter of 14 mm, an inner diameter of 10 mm, and a height of about 2 mm.

The obtained samples are evaluated for the DC bias characteristic and core loss. The DC bias characteristic is evaluated by measuring the magnetic permeability at the applied magnetic field of 52 Oe and at the frequency of 120 kHz by using an LCR meter. The core loss is measured at a measurement frequency of 110 kHz and at a measurement magnetic flux density of 0.1 T by using an alternating B-H curve measurement device. The obtained results are shown in Table 3.

As a result of the observation of the fracture surface of the samples, the aspect ratios of the inorganic insulating material in all samples are not less than 2

TABLE 3

| | Average | Average length | | | |
|---|---|---|---|---|---|
| | length of | of major axis/ | | | |
| Sample | major axis | Average particle | Magnetic | Core loss | |
| No. | (μm) | diameter | permeability | (kW/m3) | |
| 29 | 0.4 | 0.02 | 66 | 1400 | Example |
| 30 | 2 | 0.1 | 70 | 1370 | Example |
| 31 | 5 | 0.25 | 75 | 1250 | Example |
| 32 | 10 | 0.5 | 70 | 1300 | Example |
| 33 | 20 | 1 | 65 | 1420 | Example |
| 34 | 30 | 1.5 | 57 | 1605 | Comparative |
| | | | | | Example |
| 35 | 0.2 | 0.01 | 60 | 1560 | Comparative |
| | | | | | Example |

Table 3 shows that when the ratio of the average length of the major axis of the inorganic insulating material and the average particle diameter of the magnetic metal powder is in the range of 0.02 to 1, an excellent DC bias characteristic and a low core loss are exhibited.

### Example 4

Various types of magnetic metal powder having an average particle diameter of 21 μm and having aspect ratios described in Table 4 are prepared. To the prepared magnetic metal powder, 1.0 part by weight of mica having an average length of the major axis is 20 μm and having an aspect ratio of 10 is added and mixed so as to form mixed powder. To the obtained mixed powder, 0.5 parts by weight of titanium coupling agent and 0.5 parts by weight of acrylic resin are added, and then a small amount of toluene is added, followed by kneading and dispersing to form a compound. The obtained compound is pressure-formed at 10 ton/cm², and heat-treated in an argon gas atmosphere at 810° C. for 1.0 h.

Note here that the shape of the formed sample has a bar shape having 10 mm×10 mm and a length of 30 mm. The pressure-forming is carried out in the parallel direction or the vertical direction with respect to the length direction. Four samples of each are combined to form a hollow circular columnar core.

The initial magnetic permeability at a frequency of 110 kHz of the formed core is measured by using an LCR meter so as to calculate the ratio of the initial magnetic permeability of a core of a sample formed by pressure-forming in the vertical direction with respect to the length direction and that of a core of a sample formed by pressure-forming in the horizontal direction with respect to the length direction. That is to say, it is shown that as the ratio of the above-mentioned initial magnetic permeability is nearer to 1, the magnetic anisotropy is not easily provided to the core. The obtained results are shown in Table 4.

TABLE 4

| | Composition of | | Magnetic | |
|---|---|---|---|---|
| Sample | magnetic metal | Aspect | permeability | |
| No. | powder (wt %) | ratio | ratio | |
| 36 | 78Ni—4.5Mo-bal. Fe | 1 | 1 | Example |
| 37 | 78Ni—4.5Mo-bal. Fe | 1.5 | 0.99 | Example |
| 38 | 78Ni—4.5Mo-bal. Fe | 2 | 0.95 | Example |
| 39 | 78Ni—4.5Mo-bal. Fe | 3 | 0.92 | Example |
| 40 | 78Ni—4.5Mo-bal. Fe | 5 | 0.85 | Comparative |
| | | | | Example |
| 41 | 78Ni—4.5Mo-bal. Fe | 10 | 0.72 | Comparative |
| | | | | Example |
| 42 | Fe | 1 | 1 | Example |
| 43 | Fe | 1.5 | 0.98 | Example |
| 44 | Fe | 2.2 | 0.93 | Example |
| 45 | Fe | 3 | 0.91 | Example |
| 46 | Fe | 5.5 | 0.79 | Comparative |
| | | | | Example |
| 47 | Fe | 11 | 0.68 | Comparative |
| | | | | Example |
| 48 | 45Ni-bal. Fe | 1 | 1 | Example |
| 49 | 45Ni-bal. Fe | 1.5 | 0.99 | Example |
| 50 | 45Ni-bal. Fe | 1.9 | 0.95 | Example |
| 51 | 45Ni-bal. Fe | 3 | 0.93 | Example |
| 52 | 45Ni-bal. Fe | 4.7 | 0.86 | Comparative |
| | | | | Example |
| 53 | 45Ni-bal. Fe | 9.8 | 0.72 | Comparative |
| | | | | Example |
| 54 | 5.9Si-bal. Fe | 1 | 1 | Example |
| 55 | 5.9Si-bal. Fe | 1.5 | 0.99 | Example |
| 56 | 5.9Si-bal. Fe | 2 | 0.96 | Example |
| 57 | 5.9Si-bal. Fe | 3 | 0.94 | Example |
| 58 | 5.9Si-bal. Fe | 5.1 | 0.86 | Comparative |
| | | | | Example |
| 59 | 5.9Si-bal. Fe | 9.7 | 0.73 | Comparative |
| | | | | Example |
| 60 | 9.3Si—5.6Al-bal. Fe | 1 | 1 | Example |
| 61 | 9.3Si—5.6Al-bal. Fe | 1.5 | 0.99 | Example |
| 62 | 9.3Si—5.6Al-bal. Fe | 2 | 0.96 | Example |
| 63 | 9.3Si—5.6Al-bal. Fe | 3 | 0.94 | Example |
| 64 | 9.3Si—5.6Al-bal. Fe | 5 | 0.86 | Comparative |
| | | | | Example |
| 65 | 9.3Si—5.6Al-bal. Fe | 9.4 | 0.74 | Comparative |
| | | | | Example |

Table 4 shows that when the aspect ratio of the magnetic metal powder is not more than 3, and preferably not more than 1.5, the magnetic anisotropy is not easily provided to the core, and the degree of freedom in configuring the magnetic circuit is excellent.

### INDUSTRIAL APPLICABILITY

A composite magnetic body in accordance with the present invention has an excellent DC bias characteristic, a low core loss, and high mechanical strength, and is useful for magnetic material used in, in particular, a transformer core, a choke coil, a magnetic head, or the like.

1. Composite magnetic material capable of high-pressure-forming (at 5 to 20 ton/cm²) and high-temperature heat treatment (at 600 to 1000° C.), the composite magnetic material comprising:
substantially spherical magnetic metal powder;
flat inorganic insulating material interposed among the magnetic metal powder; and
a binder,
wherein the magnetic metal powder has an aspect ratio of not more than 3, and the inorganic insulating material has an aspect ratio of not less than 2 and is cleavable.

2. The composite magnetic material of claim 1,
wherein the inorganic insulating material is at least one selected from boron nitride, talc, and mica.

3. The composite magnetic material of claim 1,
wherein the magnetic metal powder is at least one selected from Fe, Fe—Si, Fe—Ni, Fe—Ni—Mo, and Fe—Si—Al based powder.

4. A process for producing composite magnetic material, the process comprising:
adding, mixing and dispersing flat inorganic insulating material to substantially spherical magnetic metal powder;
then, adding a binder thereto, and kneading and dispersing them;
pressure-forming the inorganic insulating material at 5 to 20 ton/cm² while crushing so as to form a formed product; and
heat-treating the formed product at 600 to 1000° C.,
wherein the magnetic metal powder has an aspect ratio of not more than 3, and the inorganic insulating material has an aspect ratio of not less than 4 and is cleavable.
